(19) United States
(12) Patent Application Publication
(10) Pub. No.: US 2009/0091209 A1
(43) Pub. Date: Apr. 9, 2009

(54) COMMUTATOR ROTOR OF AN ELECTRICAL MACHINE AND PROCEDURE FOR ITS MANUFACTURE

(75) Inventors: Ludvik Kumar, Spodnja Idrija (SI); Marjan Drmota, Idrija (SI)

Correspondence Address: KATTEN MUCHIN ROSENMAN LLP, 575 MADISON AVENUE, NEW YORK, NY, 10022-2585, US

(73) Assignee: KOLEKTOR GROUP D.O.O., Idrija (SI)

(21) Appl. No.: 12/267,702

(22) Filed: Nov. 10, 2008

Related U.S. Application Data
(63) Continuation of application No. PCT/EP2007/003315, filed on Apr. 14, 2007.

(30) Foreign Application Priority Data
May 10, 2006 (DE) 10 2006 021 696.2

(51) Int. Cl. H01R 39/32; H01R 43/06

(52) U.S. Cl. 310/234; 29/597

(57) ABSTRACT

A rotor exhibits a carbon commutator (4). For the manufacture of the rotor, an insulating support (9) is positioned on the rotor shaft (1). The insulating support (9) features lugs (13), around which the winding ends (8) of the rotor coils (3) are wound; after the removal of the insulation, the winding ends (8) are provided with an electrically conductive adhesive. The commutator (4) is the put on the lugs (13) with the winding ends (8). By means of this process, the winding ends (8) are mechanically and electrically directly connected to the corresponding commutator segments.

### CROSS REFERENCE TO RELATED APPLICATION

This application is a continuation of International Application PCT/EP2007/003315, filed on Apr. 14, 2007, pending at the time of filing of this continuation application and claims priority from German Patent Application DE 10 2006 021 696.2 filed May 10, 2006, the contents of which are herein wholly incorporated by reference.

### BACKGROUND OF THE INVENTION

1. Field of the Invention

The present invention relates, for one thing, to a method for the production of a rotor of a dynamoelectric machine, which has a rotor shaft, an armature core, a rotor winding produced from insulated winding wire, and a commutation unit having a plurality of segments that consist of carbon and are disposed around the rotor axis. Furthermore, the present invention relates to a rotor of a dynamoelectric machine, comprising a rotor shaft, an armature core set onto the latter, a rotor winding applied to the armature core and produced from insulated winding wire, and a commutation unit having segments that consist of carbon and are disposed around the rotor axis, to which the ends of the rotor winding are directly connected.

Dynamoelectric machines such as, in particular, direct current electric motors and generators, typically have a rotor that has a rotor shaft, an armature core, a rotor winding produced from insulated winding wire and comprising multiple coil-shaped individual windings, and a commutation unit having a plurality of segments that are disposed around the rotor axis. In this connection, the segments, whose number typically corresponds to the number of individual windings of the rotor winding, define a brush running surface, which is generally cylindrical or planar, on which the brushes grind.

In the case of dynamoelectric machines that are in broad use, the segments of the commutation unit consist of copper. In this connection, the segments—anchored in an insulating carrier body—typically have connection hooks that serve for an electrically conductive connection of the rotor winding to the segments of the commutation unit. In general, a pre-finished commutator is mounted on the rotor shaft in this connection, in each instance, and the ends of the rotor winding, i.e. the ends of the individual windings of the rotor winding, are welded to the connector hooks.

For certain applications (for example in the case of direct current motors that serve to drive fuel pumps, around which flow takes place), the segments of the commutation unit are increasingly being produced from carbon, for reasons of the useful lifetime, whereby in this connection, all of the known production methods for graphite or carbon segments (particularly from electrical carbon or carbon with polymer bonds) are understood to be included. The production of rotors for dynamoelectric machines of such applications typically takes place in corresponding manner, as explained above in connection with copper commutators, with the proviso that in the case of the pre-finished carbon commutators, the segments of the commutation unit are connected, in suitable manner, with metallic conductor elements, in electrically conductive manner, which segments are anchored in the carrier bodies of the commutator in question, and have connection hooks for the ends of the rotor winding (cf., for example, DE 19525584 A1, EP 1075727 B1, DE 10127784 A1, DE 19956844 A1). Alternatively, it has been proposed to anchor the carbon segments of the commutation unit directly on the insulating carrier body, and to fix the metallic conductor segments that have the connection hooks in place on the segments of the commutator in question (JP 08065966 A).

It has also already been proposed (JP 2000208225 A), in the case of a carbon commutator, to do without conductor segments entirely, and to connect the ends of the rotor winding directly to the segments of the commutation unit—which are anchored on the insulating carrier body—specifically in the region of the claws formed onto the segments. For the production of rotors having such carbon commutators, the above explanations apply analogously.

Furthermore, it has already been proposed for the production of a rotor of the type stated initially, in which the (roller-shaped) commutation unit comprises carbon segments, to affix a cap-shaped or bell-shaped installation element onto the rotor shaft, before installation of the actual commutation unit and before production of the rotor winding (cf. U.S. Pat. No. 3,532,913). The ends of the individual windings of the rotor winding are positioned in the correct position relative to the segments of the commutation unit to be installed later, on this element, which surrounds the commutation unit to be installed later on its outer circumference surface, which forms the brush running surface; this is done specifically by means of bores or slits. When the pre-finished commutation unit is set into the installation element, an electrically conductive connection between the ends of the rotor winding and the segments of the commutation unit is produced by means of a mechanical clamping contact.

A similar concept, in which only a mechanical clamping contact is provided—in order to avoid a welded or soldered connection between the ends of the rotor winding and the segments of the commutation unit—has also been proposed in connection with rotors whose commutation unit has metal segments (JP 09009584 A and DE 4026025 B4).

And JP 60121942 A also relates to a rotor in which the ends of the rotor winding are connected, in electrically conductive manner, solely by way of a mechanical clamping contact. For this purpose, a disk-shaped insert is disposed on the face side, on the coil carrier body that carries the coil winding. From this insert, projections project in the axial direction, around which the ends of the rotor winding are laid. In the case of the commutation unit, the segments project axially beyond the commutator carrier body. The contact of the rotor winding to the segments of the commutation unit takes place in that the ends of the rotor winding are clamped in radially on the outside, adjacent to the projections of the disk-shaped insert, between the face sides of the segments of the commutation unit, which is firmly pressed onto the rotor shaft, and the disk-shaped insert.

Finally, it has been proposed (U.S. Pat. No. 3,551,716 and DE 1910611 A) to equip a rotor of a dynamoelectric machine with a roller commutator that is easy to replace and consists of an insulating carrier body and carbon segments. For this purpose, a carrier disk made of insulating material, with metallic conductor segments affixed to it, on which the ends of the rotor winding are fixed in place on the end side, is attached to the rotor shaft, between the rotor winding and the commutator. The heads of the conductor segments, which pass through the carrier disk in the direction towards the commutator, contact the segments of the commutator unit on the face side when the commutator is set onto the rotor shaft, whereby contacting is ensured by means of the springy resilience of the carrier disk (U.S. Pat. No. 3,551,716) or the conductor segments (DE 1910611 A).

As compared with the state of the art as explained above, the present invention is based on the task of making available a method of the type explained in the introduction, for the production of a rotor of a dynamoelectric machine that is practical in use, and a rotor of the type explained in the introduction, which is practical in use, is characterized by particular efficiency, reliability, and a long useful life, and permits particularly compact outside dimensions.

This set of tasks is accomplished, according to the present invention, in that the method for the production of a rotor of a dynamoelectric machine, which has a rotor shaft, an armature core, a rotor winding produced from insulated winding wire and comprising multiple coil-shaped individual windings, and a commutation unit having a plurality of segments that consist of carbon and are disposed around the rotor axis, comprises the following steps:
setting the armature core onto the rotor shaft;
setting an insert that consists of insulating material, which has a number of projections that corresponds to the number of segments of the commutation unit, onto the rotor shaft;
applying the rotor winding to the armature core, fixing the ends of the individual windings of the rotor winding in place on the projections of the insert, in that the ends of each individual winding of the rotor winding are wound around the related projection of the insert, in each instance, and removing the insulation from the winding wire at the ends of the individual windings of the rotor winding;
applying an electrically conductive adhesive to the shiny ends of the individual windings of the rotor winding that have been wound around the projections and/or to a face surface of a commutation component that comprises the segments of the commutation unit;
setting the commutation component onto the rotor shaft and/or the insert in such a manner that the projections of the insert come to lie directly adjacent to a face surface section of the segments of the commutation unit, in each instance, whereby the ends of the individual windings of the rotor winding that are wound around the projections are contacted, in electrically conductive manner, with the related segment of the commutation unit, in each instance, in the region of the face surface sections of the segments of the commutation unit, whereby the electrically conductive connections of the ends of the individual windings of the rotor winding with the segments of the commutation unit are produced by means of soldering, whereby at least the axial face surface sections of the segments of the commutation unit that serve to produce the connection with the ends of the individual windings of the rotor winding were previously surface-metallized.

A rotor of the type indicated initially, structured according to the present invention, is characterized by an insert set onto the rotor shaft, disposed axially between the armature core and the commutation unit, made of insulating material, which has a number of projections that corresponds to the number of segments of the commutation unit, which projections are disposed, in each instance, directly adjacent to a face surface section of the of the segments of the commutation unit, and on which the shiny ends of the individual windings of the rotor winding are fixed in place, in that they are wound around the related projection, in each instance, whereby in the region of the face surface sections of the segments of the commutation unit, the ends of the individual windings of the rotor winding that are wound around the projections are contacted with the related segment of the commutation unit, in each instance, in direct electrically conductive manner, and with the formation of a firm connection, by means of the adhesive, whereby the electrically conductive connections of the ends of the individual windings of the rotor winding with the segments of the commutation unit are produced by means of a solder connection.

A central characteristic of the present invention accordingly consists of the fact that the electrically conductive connections between the ends of the individual windings of the rotor winding and the segments of the commutation unit are produced, in each instance, in a (particularly an axial) face surface section of the segments of the commutation unit. For this purpose, the insert that consists of insulating material and is set onto the rotor shaft has a number of projections that corresponds to the number of segments of the commutation unit, which come to lie directly adjacent to a face surface section of the segments of the commutation unit, in each instance, during further assembly, namely when the commutation unit is axially set onto the rotor shaft and/or the insert. The ends of the rotor winding are fixed in place on the projections of the insert, which are generally arm-shaped, whose radial expanse is less than the radius of the commutation component, and which therefore do not project radially beyond the commutation component, i.e. the commutation unit that proceeds from it, in such a manner that they are electrically contacted with the (axial) face surface sections of the segments of the commutation unit, in direct manner when the commutation unit is axially set onto the rotor shaft and/or the insert, in the region of these sections, specifically with the production of a firm connection, by means of an electrically conductive adhesive (solder). Metallic conductor segments as a conductive intermediate element between the ends of the rotor winding and the carbon segments are therefore not provided according to the present invention. The contact points of the ends of the rotor winding with the segments of the commutation unit, which are particularly sensitive, especially in the case of direct contacting of the rotor winding with carbon segments, can be disposed relatively close to the axis of the rotor when the invention is used, so that only slight centripetal forces act on the individual elements of the contact points. Furthermore, the contact points, which are generally restricted to the aforementioned face surface sections, can be accommodated in protected manner, and, if necessary, actually have plastic or pressed material cast or injection-molded around them, together with the armature core and the rotor winding. The invention has an advantageous effect with regard to the smallest possible dimensions of the rotor, as well. And installation of the commutation unit only after production of the rotor winding and fixation of the ends of the rotor winding to the projections of the insert prevents damage to the sensitive carbon segments during handling of the rotor blank.

To produce, secure, and support the electrically conductive connections of the ends of the rotor winding with the segments of the commutation unit, a known method (soldering) is used, whereby the segments of the commutation unit are previously (partially) surface-metallized, in known manner. It is practical if the solder is applied to the projections and the (shiny) ends of the rotor winding fixed in place there and/or to the face surface sections of the segments, as a paste, before the commutation component is set on, and if the unit is heated after the commutation component has been installed, to a temperature above the softening temperature of the solder.

The statement according to which the ends of the rotor winding, i.e. the ends of the individual windings of the rotor winding, are fixed in place on the projections of the insert by being wound around them, is not allowed to be interpreted restrictively to the effect that the winding wire from which the individual windings can be produced continuously, without interruption, in one piece, must be separated between two individual windings, in each instance. Instead, an end of an individual winding can make a transition, without interruption, into an end of the adjacent, subsequently wound individual winding. The advantages of the present invention are particularly marked specifically in this case; this is because after an individual winding of the rotor winding is wound, the winding wire only has to be laid around the projection of the insert once, or multiple times if necessary, before winding of the adjacent individual winding starts.

The removal of the insulation from the winding wire in the region of the ends of the rotor winding can take place, depending on the particular conditions, during production of the rotor winding (i.e. successively while winding the rotor winding) or subsequent to this. Removal of the insulation during the production of the rotor winding, i.e. between winding of two consecutive individual windings, in each instance, has the advantage that the ends of the rotor winding can be freed of the insulation over a large area, and this promotes the production of a good contact with the carbon segments; however, in this case the production of the rotor winding takes correspondingly more time. Removal of the insulation after completing the winding of the rotor winding leads to more practical results, and has the advantage that the production of the rotor winding is not delayed. This is particularly advantageous from the aspect of economic efficiency. The manner (mechanical, chemical, thermally, or in some other way) in which removal of the insulation of the winding wire takes place in the region of the ends of the rotor winding is guided by the conditions of the individual case, and depends, for example, on the type of insulation.

While the present invention can fundamentally be used independent of the geometry of the brush surface (planar, cylindrical, or in some other way), it proves to be particularly advantageous in connection with commutation units having a planar brush running surface, i.e. in applications in which carbon planar commutators were or are traditionally used, as will become evident from the following explanations.

According to preferred further developments of the invention, the ends of the rotor winding are wound around the projections of the insert multiple times, to fix them in place on the projections, and/or drawn into notches provided in the inserts, in which the wire of the rotor winding clamps in place. The aforementioned notches particularly preferably do not extend completely around the projections, but rather only over those regions of the projections that do not stand directly opposite the face surface sections of the segments of the commutation unit that serve to produce the electrically conductive connection with the rotor winding. There, the ends of the rotor winding should be exposed as much as possible, in order to create optimal prerequisites for a permanent electrically conductive connection with the segments.

In multiple respects, it is particularly advantageous if, according to yet another further development of the invention, the commutation component to be installed comprises a ring-shaped or sleeve-shaped carbon blank, in which the individual segments of the commutation unit are only separated from one another after production of the electrically conductive connection of the segments of the commutation unit with the rotor winding. Extraordinary advantages result, in this regard, if the commutation component consists merely of a ring-shaped or sleeve-shaped blank that is set onto the insert, and has plastic or pressed material cast or injection-molded around it before separation of the individual segments of the commutation unit, at least in part, together with the insert, the armature core, and the rotor winding. In this connection, centering projections provided on the insert can ensure that the insert and carbon blank are disposed in the correct position, aligned with one another. If the rotor shaft prevents separation of the individual segments of the commutation unit—particularly in the case of commutation units having a planar brush running surface—it can be axially displaced, if necessary, before separation of the individual segments of the commutation unit. This applies not only if the rotor shaft on which the rotor is being produced is a pure installation shaft that is subsequently replaced with an operating shaft. Even if the rotor is being produced on the operating shaft right from the start, the rotor shaft can be axially displaced temporarily, in order to be able to separate the segments of the commutation unit, which are at first connected with one another to form a closed ring or a closed sleeve.

The configuration characteristics indicated above are by no means compulsory. Other further developments of the invention that are particularly advantageous for specific cases of use are characterized in that the commutation component to be installed has an insulating carrier body and segments of the commutation unit that are anchored in this body, already separated and insulated relative to one another. In this case, the commutation unit—with its insulating carrier body—can be installed on the rotor shaft itself. In any case, the insert by no means has a compulsory function of centering the commutation component or the segments of the commutation unit, as is the case with a carrier-free commutation unit in the sense described above. In this case, the carrier body of the commutation part has recesses or windows that release the (axial) face surface sections that serve to produce the electrically conductive connections between the ends of the rotor winding and the segments of the commutation unit. Since, in an application of the present invention, the ends of the rotor winding cannot be connected to the commutation unit by means of welding, it is cost-advantageously possible to produce the carrier body of the commutation component from thermoplastic material.

According to yet another further development of the invention, it is provided that the insert has an outer contact surface for the rotor winding that essentially widens conically in the direction towards the commutation unit. In this manner, the insert can delimit and define the space that is available for the production of the rotor winding, and support the rotor winding, something that is particularly advantageous with regard to a particularly compact method of construction. In this way, insert, armature core, and rotor winding can form a compact, firm unit, which can actually be handled without a shaft, if necessary.

The present invention will be explained in greater detail in the following, using four preferred exemplary embodiments shown in the drawing. There, the figures show:

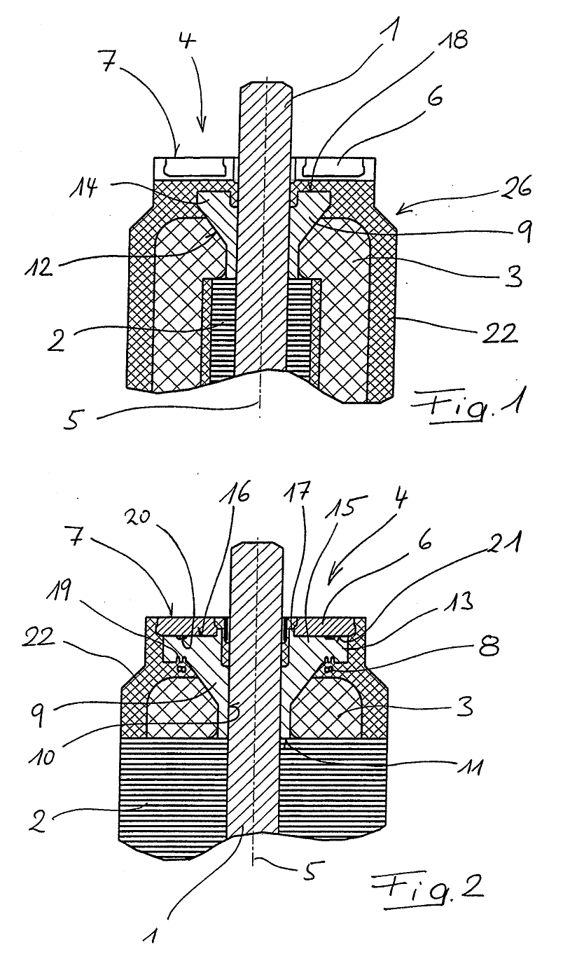

FIG. 1 an axial section through a first embodiment of a rotor of a direct current electric motor having a planar brush running surface, produced using the present invention,

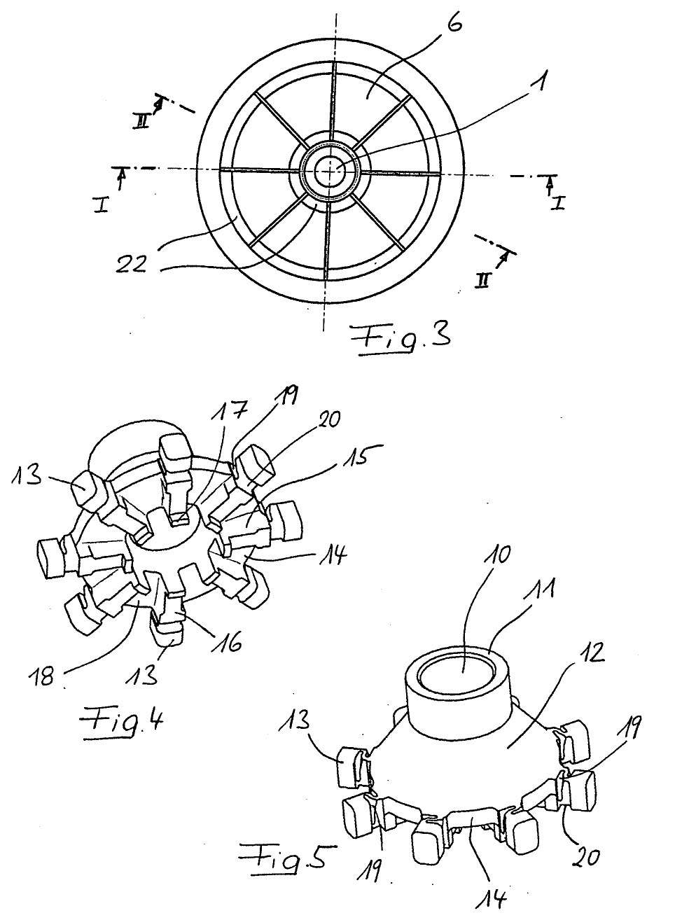

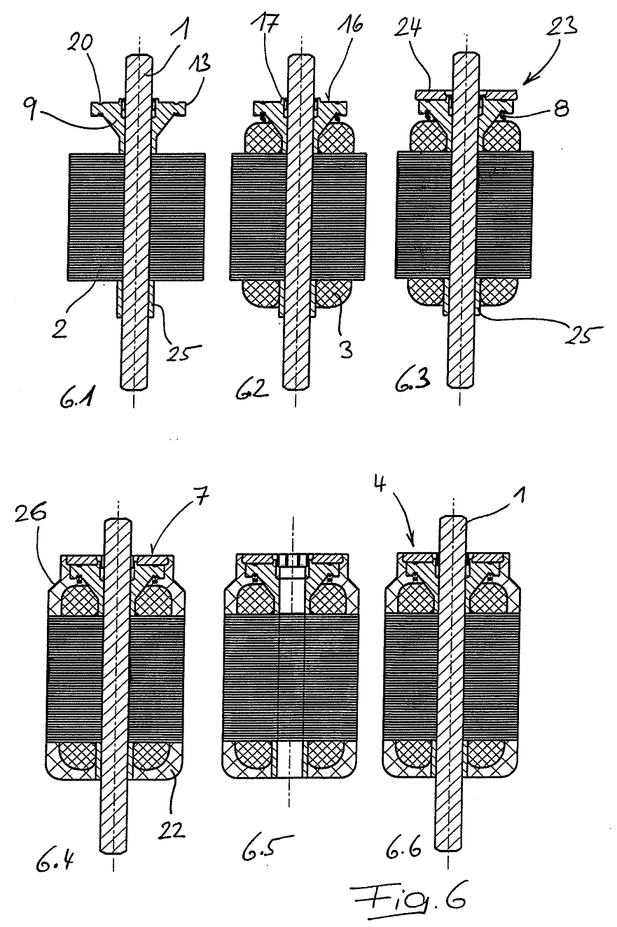

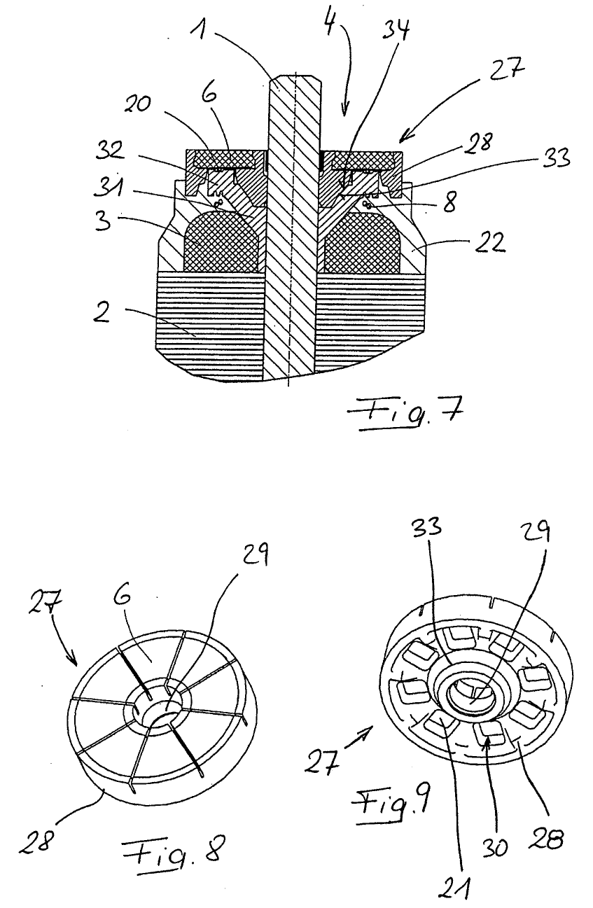

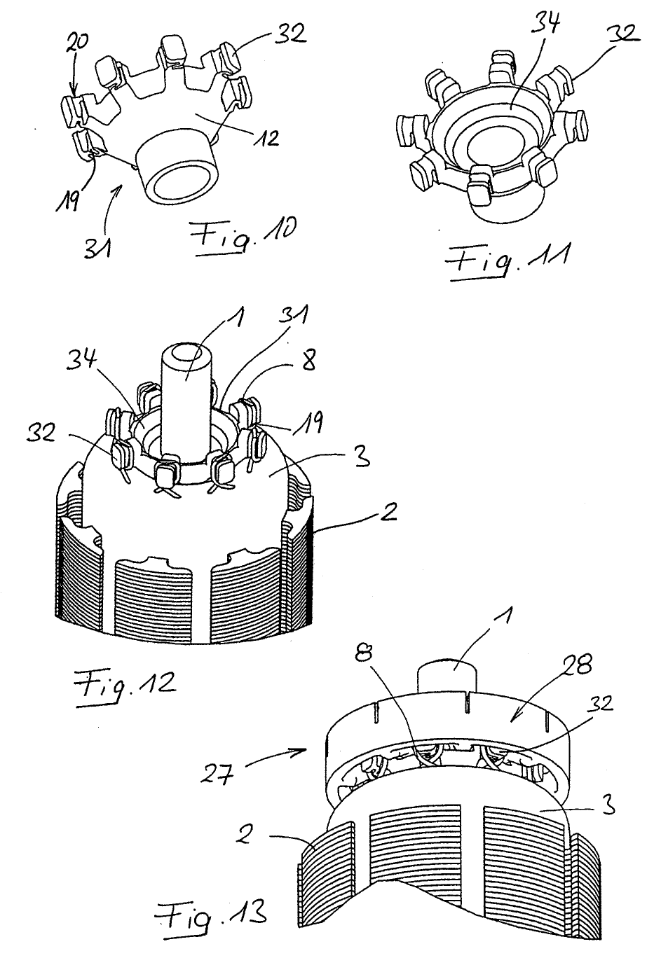

FIG. 2 another axial section through the rotor shown in FIG. 1, in a different plane,

FIG. 3 a face side top view of the rotor according to FIGS. 1 and 2,

FIG. 4 in a perspective view, the insert used for production of the rotor according to FIG. 1 to 3, and

FIG. 5 the insert according to FIG. 4 from a different perspective.

FIG. 6 illustrates the sequence of production of the rotor according to FIG. 1 to 3 in multiple steps. Furthermore,

FIG. 7 shows an axial section through a second embodiment of a rotor of a direct current electric motor having a planar brush running surface, produced using the present invention,

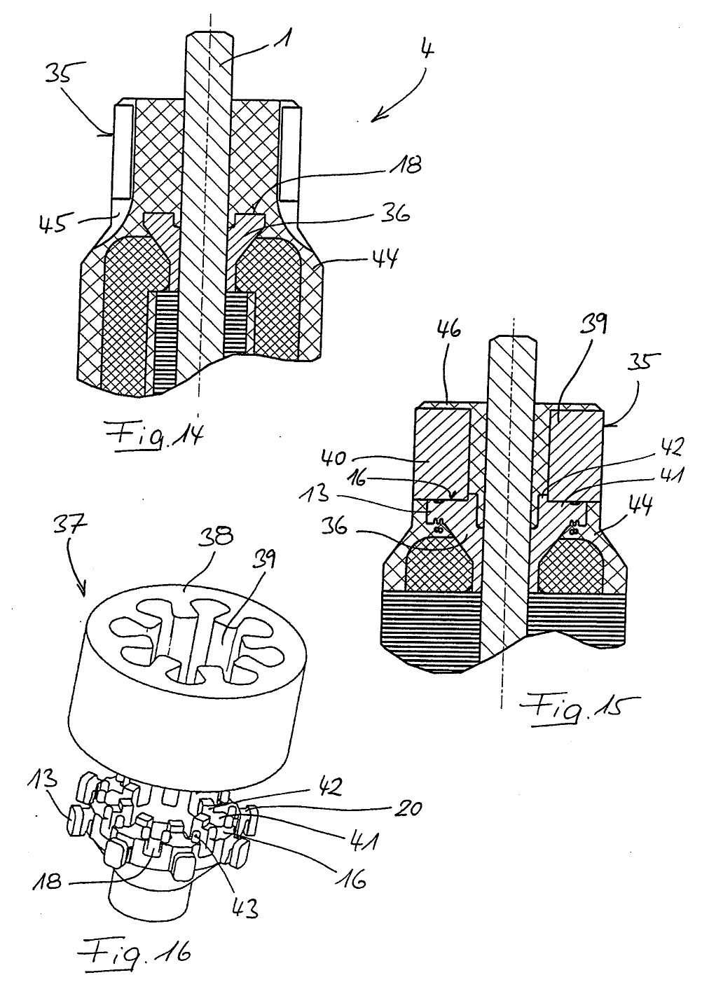

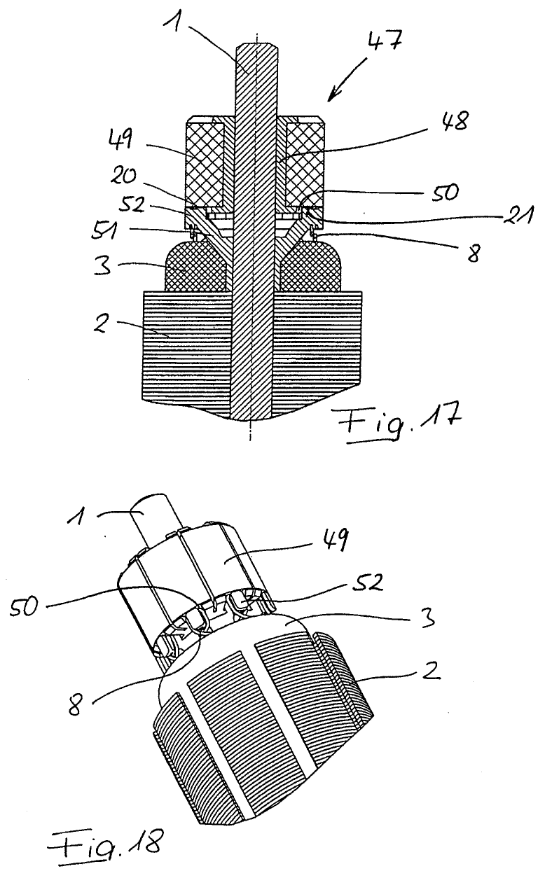

FIG. 8 in a perspective view, shows the commutation component used for production of the rotor according to FIG. 7,

FIG. 9 shows the commutation part according to FIG. 8 from a different perspective,

FIG. 10 in a perspective view, shows the insert used for production of the rotor according to FIG. 7,

FIG. 11 shows the insert according to FIG. 10 from a different perspective,

FIG. 12 in a perspective view, shows the rotor blank before installation of the commutation component, and

FIG. 13 shows the rotor blank according to FIG. 12 from a different perspective, after installation of the commutation component. Furthermore,

FIG. 14 shows a first axial section through a third embodiment of a rotor of a direct current electric motor having a cylindrical brush running surface, produced using the present invention,

FIG. 15 shows another axial section through the rotor shown in FIG. 14, in a different plane,

FIG. 16 in a perspective view, shows the insert used for production of the rotor according to FIGS. 14 and 15, and the commutation component to be set onto this insert. Finally,

FIG. 17 shows an axial section through a fourth embodiment of a rotor of a direct current electric motor having a cylindrical brush running surface, produced using the present invention, and

FIG. 18 shows the rotor according to FIG. 17 from a different perspective.

The rotor of a dynamoelectric machine illustrated in FIG. 1 to 6 of the drawing comprises a rotor shaft 1, an armature core 2 set onto the latter, a rotor winding 3 applied to the armature core, and a commutation unit 4. The commutation unit 4 comprises eight segments 6, consisting of carbon, disposed around the rotor axis 5, which define a planar brush running surface 7 disposed perpendicular to the rotor axis 5. The rotor winding, produced from insulated winding wire, accordingly comprises eight coil-shaped individual windings. To this extent, the rotor shown corresponds to the well-known state of the art, so that no further explanations are required.

For a direct connection of the ends 8 of the individual windings of the rotor winding 3 to the segments 6 of the commutation unit 4, an insert 9 consisting of insulating material, having a shaft bore 10, is set onto the rotor shaft 1. The insert 9 lies against the armature core 2 with a face surface 11. It has an outer contact surface 12 for the rotor winding 3, which essentially widens conically in the direction towards the commutation unit 4. Furthermore, the insert 9 has eight projections 13 in the form of radially oriented, arm-shaped projections, which both project radially towards the outside, beyond the core 14, and are offset relative to the core 14, axially, in the direction towards the segments 6 of the commutation unit 4. Radially towards the inside, the projections 13 experience an extension in the form of ribs 15 that project from the face side 18 of the core 14 of the insert 9. The ribs 15, in each instance, have a contact surface 16 for the related segment 6 of the commutation unit 4, whereby the eight contact surfaces 16 lie in a common plane, parallel to the brush running surface 7. Radially on the inside, centering projections 17 project from the ribs, and the segments 6 of the commutation unit 4 lie against these with their radially inner edges, in each instance.

To fix the ends 8 of the rotor winding in place on the projections 13 of the insert 9, the projections 13 have notches 19 whose clear width is coordinated with the diameter of the wire used for the production of the rotor winding, in such a manner that the winding wire is wound around the projections 13 multiple times, in the region of the ends 8 of the rotor winding, and clamped in place in the notches 19 into which it is drawn. The notches 19 are marked only in those regions of the projections 13 that face away from the segments 6 of the commutation unit 4. In contrast, facing the segments 6, the projections 13 have flat, bowl-shaped depressions 20, which are set back, relative to the contact surfaces 16, by about the thickness of the wire used for production of the rotor winding, and serve to accommodate multiple wraps of the ends 8 of the rotor winding disposed radially next to one another.

Contacting of the segments 6 of the commutation unit 4 with the ends 8 of the rotor winding 3 takes place in the region of the face surface sections 21 of the segments 6. Here, the ends 8 of the rotor winding that have been freed of their insulation and wound around the projections 13 are connected with the segments 6, using electrically conductive adhesive, without the corresponding surface of the segments being metallized.

Radially on the outside and radially on the inside, the segments 6 of the commutation unit 4—appropriately profiled—are surrounded by plastic 22, in which the armature core 2 and the rotor winding 3 are also embedded. In this connection, the plastic 22 also surrounds projections 13 there where the segments 6 do not rest against them, and in this way additionally contributes to fixing the ends 8 of the rotor winding 3 in place on the projections 13.

For the production of the rotor shown in FIG. 1 to 3, it is characteristic that the commutation component 23 that is set onto the insert 9 consists merely of a carbon ring disk 24. FIG. 6 illustrates, in step 6.3, the placement of the carbon ring disk 24 onto the insert 9, with production of the electrically conductive connections to the ends of the rotor winding, in the manner explained above. Subsequently, as shown in step 6.4, the component consisting of armature core 2, rotor winding 3, insert 9, and carbon ring disk 24 has plastic 22 cast around it, whereby the plastic also rests against the underside of the segments 6, beyond the core 14 of the insert 9, in accordance with the elevation of the ribs 15, and anchors the segments, and only the brush running surface 7 remains free. A sleeve 25 set onto the rotor shaft 1, opposite the insert 9, is cast into the plastic 22; this prevents damage of the plastic 22 when the rotor shaft 1 is pressed out. After the rotor shaft has been removed, the carbon ring disk 14 is sawn apart using radial cuts, in order to separate the individual segments 6 of the commutation unit from one another, and to isolate them relative to one another (step 6.5). Subsequently, the operating shaft is installed as the final rotor shaft 1 (step 6.6). In order not to damage the commutation unit 4 when the operating shaft is pressed in, the body made from plastic 22 has a shoulder 26, on which the body supports itself when the operating shaft is pressed in.

The embodiment according to FIG. 7 to 13 is characterized, as compared with the embodiment explained above, according to FIG. 1 to 6, in that the commutation component 27 to be installed has an insulating carrier body 28 and segments 6 of the commutation unit 4 that are anchored in it, already separated from one another and insulated relative to one another. The commutation component 27 is installed directly onto the rotor shaft 1, and for this purpose, the carrier body 28 has a shaft bore 29. Furthermore, the carrier body of the commutation component has windows 30 that release axial face surface sections 21 of the segments 6 of the commutation unit 4, and, in this manner, allow the production of electrically conductive connections between the ends of the rotor winding and the segments, in the region of specifically those axial face surface sections 21.

The insert 31, to be installed on the rotor shaft 1, is adapted to the specific embodiment of the commutation component 27 for this purpose. The projections 32 are structured in such a manner that they can enter into the windows 30 of the carrier body 28 of the commutation component 27. The orientation of insert 31 and commutation component 27, so as to align with one another, is supported by fitting surfaces 33, 34 having an essentially conical shape, which correspond to one another.

For the remainder, the structural characteristics of the rotor according to FIG. 7 to 13 and the method that serves for its production are evident form the above explanations regarding FIG. 1 to 6, so that reference is made to these, in order to avoid repetition.

FIG. 14 to 16 illustrate a rotor structured according to the present invention, whose commutation unit 4 has a cylindrical brush running surface 35. The commutation part 37, which is to be installed on the insert 36 during the course of production, consists exclusively of a carbon sleeve 38, the inner circumference surface of which is profiled in meander shape, to form undercut armature sections 39 for the segments 40. To center the carbon sleeve 38 on the insert 36, the latter has not only centering projections 42 that, project axially, radially on the inside, from the ribs 41, but in addition, also centering nubs 43 that accommodate an armature section 39 between them, in pairs, in each instance, and thus guarantee precise angular orientation of carbon sleeve 38 and insert 36 relative to one another.

Once the pre-assembled unit consisting of rotor shaft 1, armature core 2, rotor winding 3, insert 36, and commutation component 37 has had plastic 44 cast around it, the carbon sleeve 38 is divided by means of saw cuts 45, thereby separating the individual segments 40 from one another and insulating them relative to one another. The plastic 44 forms an end disk 46 on the axial face side of the commutation unit 4, which equally protects the segments 40 mechanically and additionally fixes them in place.

As a result of the carrier-free structure of the commutation component 37, there are significant structural parallels with the embodiment according to FIG. 1 to 6, so that with regard to further details, reference is made to the explanations of these figures, in order to avoid repetition.

Different from the embodiment according to FIG. 14 to 16, in the case of the rotor according to FIGS. 17 and 18, the commutation component 47 to be directly installed onto the rotor shaft 1 has an insulating carrier body 48 and individual carbon segments 49 that are anchored in it and separated from one another. The carrier body 48 possesses recesses 50 that release axial face surface sections 21 of the segments 49, in order to allow the production of electrically conductive connections between the ends 8 of the rotor winding 3 and the segments 49 in the region of specifically these axial face surface sections 21. The insert 51 to be installed onto the rotor shaft 1 is adapted to the specific embodiment of the commutation component 47 for this purpose. The projections 52 are structured in such a manner that they can enter into the recesses 50 of the carrier body 48 of the commutation component 47. For the remainder, the structural and production-specific aspects of the rotor according to FIGS. 17 and 18 are evident from the above explanations of the embodiments that have already been described.

1. Method for the production of a rotor of a dynamoelectric machine, which has a rotor shaft (1), an armature core (2), a rotor winding (3) produced from insulated winding wire and comprising multiple coil-shaped individual windings, and a commutation unit (4) having a plurality of segments (6, 40, 49) that consist of carbon and are disposed around the rotor axis (5), comprising the following steps:
setting the armature core (2) onto the rotor shaft (1);
setting an insert (9, 31, 36, 51) that consists of insulating material, which has a number of projections (13, 32, 52) that corresponds to the number of segments of the commutation unit, onto the rotor shaft;
applying the rotor winding (3) to the armature core, fixing the ends (8) of the individual windings of the rotor winding in place on the projections of the insert, in that the ends of each individual winding of the rotor winding are wound around the related projection of the insert, in each instance, and removing the insulation from the winding wire at the ends of the individual windings of the rotor winding;
applying an electrically conductive adhesive to the shiny ends of the individual windings of the rotor winding that have been wound around the projections and/or to a face surface of a commutation component (23, 27, 37, 47) that comprises the segments of the commutation unit;
setting the commutation component (23, 27, 37, 47) onto the rotor shaft and/or the insert in such a manner that the projections of the insert come to lie directly adjacent to a face surface section (21) of the segments of the commutation unit, in each instance, whereby the ends of the individual windings of the rotor winding that are wound around the projections are contacted, in electrically conductive manner, with the related segment of the commutation unit, in each instance, in the region of the face surface sections of the segments of the commutation unit, with the production of a firm connection, whereby the electrically conductive connections of the ends (8) of the individual windings of the rotor winding (3) with the segments (6, 40, 49) of the commutation unit are produced by means of soldering, whereby at least the axial face surface sections of the segments of the commutation unit that serve to produce the connection with the ends of the individual windings of the rotor winding were previously surface-metallized.

2. Method according to claim 1,
characterized in that
the ends (8) of the individual windings of the rotor winding (3) are drawn into notches (19) provided in the projections, to fix them in place on the projections (13, 32, 52) of the insert (9, 31, 36, 51).

3. Method according to claim 1,
characterized in that
the ends (8) of the individual windings of the rotor winding (3) are wound around the projections multiple times, to fix them in place on the projections (13, 32, 52) of the insert (9, 31, 36, 51).

4. Method according to claim 1,
characterized in that
the production of the electrically conductive connections between the ends (8) of the individual windings of the rotor winding (3) and the segments (6, 40, 49) of the commutation unit (4) takes place directly when the commutation component (23, 27, 37, 48) is set on.

5. Method according to claim 1,
characterized in that
the commutation component comprises a ring-shaped or sleeve-shaped carbon blank (24, 38), in which the individual segments (6, 40) of the commutation unit (4) are only separated from one another after production of the electrically conductive connection of the segments of the commutation unit with the rotor winding (3).

6. Method according to claim 5,
characterized in that
the commutation component consists merely of a ring-shaped or sleeve-shaped blank (24, 38) that is set onto the insert (9, 36), and has plastic (22, 44) or pressed material cast or injection-molded around it before separation of the individual segments (6, 40) of the commutation unit (4), at least in part, together with the insert, the armature core (2), and the rotor winding (3).

7. Method according to claim 5,
characterized in that
the rotor shaft (1) is axially displaced before the separation of the individual segments (6) of the commutation unit (4) of the ring-shaped carbon blank (24).

8. Method according to claim 1,
characterized in that
the commutation component (27) has an insulating carrier body (28) and separate segments (6) of the commutation unit, anchored in it, and insulated relative to one another.

9. Method according to claim 1,
characterized in that
the rotor shaft (1) is a pure installation shaft that is subsequently replaced with an operating shaft.

10. Rotor of a dynamoelectric machine, comprising a rotor shaft (1), an armature core (2) set onto the latter, a rotor winding (3) applied to the armature core and produced from insulated winding wire, comprising multiple coil-shaped individual windings, and a commutation unit (4) having segments (6, 40, 49) that consist of carbon and are disposed around the rotor axis, to which the ends (8) of the rotor winding are directly connected, characterized by an insert (9, 31, 36, 51) set onto the rotor shaft, disposed axially between the armature core and the commutation unit, made of insulating material, which has a number of projections (13, 32, 52) that corresponds to the number of segments of the commutation unit, which projections are disposed, in each instance, directly adjacent to a face surface section (21) of the of the segments of the commutation unit, and on which the shiny ends of the individual windings of the rotor winding are fixed in place, in that they are wound around the related projection, in each instance, whereby in the region of the face surface sections of the segments of the commutation unit, the ends of the individual windings of the rotor winding that are wound around the projections are contacted with the related segment of the commutation unit, in each instance, in direct electrically conductive manner, and with the formation of a firm connection, by means of the adhesive, whereby the electrically conductive connections of the ends (8) of the individual windings of the rotor winding (3) with the segments of the commutation unit (4) are produced by means of a solder connection.

11. Rotor according to claim 10,
characterized in that
the insert (9, 31, 36, 51) has an outer contact surface (12) for the rotor winding (3) that essentially widens conically in the direction towards the commutation unit (4).

12. Rotor according to claim 10,
characterized in that
the ends (8) of the individual windings of the rotor winding (3) are drawn into notches (19) provided in the projections, to fix them in place on the projections (13, 32, 52) of the insert (9, 31, 36, 51).

13. Rotor according to claim 10,
characterized in that
the ends (8) of the individual windings of the rotor winding (3) are wound around the projections multiple times, to fix them in place on the projections (13, 32, 52) of the insert (9, 31, 36, 51).

14. Rotor according to claim 10,
characterized in that
the segments (6) of the commutation unit (4) are centered by means of centering projections (17, 42) of the insert (9, 36) and anchored in plastic (22, 44) or pressed material, which is also cast or injection-molded around the insert, the armature core (3), and the rotor winding (3).
